(19) United States
(12) Patent Application Publication
(10) Pub. No.: US 2024/0268429 A1
(43) Pub. Date: Aug. 15, 2024

(54) OIL IMPREGNATED SUBSTRATE

(71) Applicant: Aaron D. Shapiro, Woodland Hills, CA (US)

(72) Inventor: Aaron D. Shapiro, Woodland Hills, CA (US)

(21) Appl. No.: 18/438,356

(22) Filed: Feb. 9, 2024

Related U.S. Application Data
(60) Provisional application No. 63/444,845, filed on Feb. 10, 2023.

(51) Int. Cl. A23L 27/00; B65B 25/00; B65B 51/10

(52) U.S. Cl. CPC A23L 27/74; A23P 10/10; B65B 25/00; B65B 51/10

(57) ABSTRACT

Disclosed embodiments provide a substrate that can be used to apply an oil-based seasoning mixture on to a cooking surface in order to season food and to prevent the food from burning at a variety of cooking temperatures. The substrate includes a felt that is constructed with a matted fabric. The felt allows for absorption of liquid solutions into the matted fabric and for the transfer of these liquid solutions from the matted fabric onto a cooking surface. The substrate further includes an oil-based seasoning mixture that is infused into the matted fabric of the felt. The oil-based seasoning mixture includes an oil that is selected based on its smoke point. Further, the oil-based seasoning mixture includes seasonings that are infused into the oil.

### CROSS-REFERENCES TO RELATED APPLICATIONS

This application claims the benefit of U.S. Provisional Patent Application No. 63/444,845, filed on Feb. 10, 2023 which are incorporated herein by reference in their entirety.

### FIELD

The present disclosure relates generally to a substrate that is impregnated or infused with a seasoning-oil mixture and which can be applied to various cooking implements to provide seasoning and moisture retention for foods that can be prepared using the various cooking implements.

### SUMMARY

Disclosed embodiments provide a method for manufacturing an oil impregnated substrate that can be used at any temperature and on any cooking surface in order to season foods being prepared on a cooking surface while retaining the moisture of these foods during cooking. The substrate is infused or impregnated with a mixture of an oil suitable for cooking and one or more seasonings (e.g., spices, herbs, vinegar, etc.) that can be transferred to a cooking surface by gently wiping the substrate on to the cooking surface. The transfer of the mixture to the cooking surface may result in a lubricated cooking surface that prevents food from sticking to the cooking surface during food preparation. Further, as the food is being prepared on the lubricated cooking surface, the mixture may produce an aroma corresponding to the one or more seasonings applied to the mixture. This aroma may produce a satisfying olfactory response to the individuals preparing the food and to the consumers of the food being prepared. Further, the aroma may be transferred to the food, thereby seasoning the food according to the one or more seasonings included in the mixture.

The application of the infused oil-based seasoning mixture to the cooking surface may provide additional benefits. For instance, the oil selected for the oil-based seasoning mixture may have a high flash point such that oil vapors generated during higher cooking temperatures do not ignite, causing flare ups that may be hazardous to consumers. Further, the oil selected for the oil-based seasoning mixture may have a high smoke point such that the oil does not produce an acrid aroma at higher cooking temperatures, which can also impact the flavor of the food being prepared. Further, at higher cooking temperatures, the oil used in the oil-based seasoning mixture may not break down quickly, thereby maintaining the lubricated cooking surface for the food and preventing sticking of the food on to the cooking surface during preparation. Additionally, as the food is being prepared, the oil-based seasoning mixture can be transferred from the lubricated cooking surface to the food. This allows for the food to retain moisture, preventing the food from drying out during preparation, and to be seasoned based on the one or more seasonings applied to the mixture.

Additionally, the application of the infused oil-based seasoning mixture to the cooking surface can be performed at any temperature. For example, a user may gently wipe the substrate along the cooking surface at room temperature in order to transfer the infused oil-based seasoning mixture onto the cooking surface. This use of the substrate at room temperature may significantly reduce any risk to the user associated with applying the infused oil-based seasoning mixture onto the cooking surface, as the user may not be required to use the substrate at cooking temperatures. Further, the properties of the substrate allow for transfer of the infused oil-based seasoning mixture onto the cooking surface with gentle or minimal pressure regardless of the temperature of the cooking surface.

According to some embodiments, a method is provided. The method comprises receiving a substrate roll. The substrate roll is sized according to a pre-defined set of dimensions for individual substrates and a resulting quantity of the individual substrates. The method further comprises slitting the substrate roll according to the pre-defined set of dimensions to obtain the individual substrates. The method further comprises automatically inserting the individual substrates into corresponding individual substrate packages. The individual substrate packages are sized according to the pre-defined set of dimensions for the individual substrates. The method further comprises injecting an amount of an oil-based seasoning mixture into the individual substrate packages. The amount of the oil-based seasoning mixture is defined according to a set of absorption properties of the individual substrates and the pre-defined set of dimensions. The method further comprises sealing the individual substrate packages such that when the individual substrate packages are sealed, the individual substrates absorb the amount of the oil-based seasoning mixture. The method further comprises providing the sealed individual substrate packages.

In some embodiments, the oil-based seasoning mixture comprises an oil having a smoke point corresponding to a maximum cooking temperature for cooking of food. The oil does not burn at the maximum cooking temperature.

In some embodiments, the oil-based seasoning mixture comprises an oil and a set of seasonings. The set of seasonings are infused into the oil by heating the set of seasonings and the oil within a container. Further, the set of seasonings and the oil are heated within the container without cooking the oil.

In some embodiments, the individual substrates are constructed using a polyester felt. The polyester felt is generated using recycled plastic.

In some embodiments, the amount of the oil-based seasoning mixture is between 0.20 and 0.30 fluid ounces per individual substrate package of the individual substrate packages.

In some embodiments, the amount of the oil-based seasoning mixture is injected into the individual substrate packages by pumping the amount of the oil-based seasoning mixture from an oil tote through a set of injectors into the individual substrate packages.

In some embodiments, the oil-based seasoning mixture comprises an oil having a flash point corresponding to a maximum cooking temperature for cooking of food, The vapors generated from the oil during cooking do not ignite at the maximum cooking temperature.

In some embodiments, the individual substrate packages are sealed by removing excess air from the individual substrate packages and applying heat along an open end of the individual substrate packages.

In some embodiments, the oil-based seasoning mixture includes an oil chosen from a group consisting of safflower oil, avocado oil, rice bran oil, olive oil, soybean oil, and peanut oil.

In some embodiments, the individual substrates allow for a transfer of the oil-based seasoning mixture from the individual substrates to a cooking surface at room temperature and using gentle force.

According to some embodiments, a substrate is provided. The substrate comprises a felt. The felt comprises a matted fabric that allows for absorption of liquid solutions into the matted fabric. The felt further allows for transfer of the liquid solutions from the matted fabric on to a cooking surface through a wiping motion performed along the cooking surface at a room temperature or a cooking temperature. The substrate further comprises an oil-based seasoning mixture that is impregnated into the matted fabric to saturate the felt. The oil-based seasoning mixture comprises an oil suitable for cooking of a food. The oil is selected based on a smoke point associated with the oil, where the smoke point corresponds to the cooking temperature. The seasoning mixture further comprises one or more seasonings. The one or more seasonings are infused into the oil.

In some embodiments, the oil-based seasoning mixture is impregnated into the matted fabric using a set of injectors. The oil-based seasoning mixture is pumped into the set of injectors from a container in order to inject the oil-based seasoning mixture into the matted fabric.

In some embodiments, the matted fabric is generated using a polyester constructed using recycled plastic.

In some embodiments, the smoke point associated with the oil corresponds to a maximum cooking temperature for cooking of the food. The oil does not burn at the maximum cooking temperature.

In some embodiments, the oil is further selected based on a flash point associated with the oil. The flash point corresponds to a maximum cooking temperature. Further, vapors generated from the oil during cooking do not ignite at the maximum cooking temperature.

In some embodiments, an amount of the oil-based seasoning mixture used for saturation of the felt is between 0.20 and 0.30 fluid ounces.

In some embodiments, the one or more seasonings are infused into the oil by heating the one or more seasonings and the oil within a container. The one or more seasonings and the oil are heated within the container without cooking the oil.

In some embodiments, the oil is chosen from a group consisting of safflower oil, avocado oil, rice bran oil, olive oil, soybean oil, and peanut oil.

In some embodiments, the felt further allows for transfer of the liquid solutions from the matted fabric to the cooking surface at a room temperature.

In some embodiments, the felt further allows for transfer of the liquid solutions from the matted fabric to the cooking surface at the cooking temperature.

This summary is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The foregoing, together with other features and examples, will be described in more detail below in the following specification, claims, and accompanying drawings.

### BRIEF DESCRIPTION OF THE DRAWINGS

The present disclosure is described in conjunction with the appended Figures:

FIGS. 1A-1B show an illustrative example of an environment in which an oil impregnated substrate is applied to a cooking surface to transfer an oil-based seasoning mixture from the oil impregnated substrate to the cooking surface to season food being prepared on the cooking surface in accordance with at least one embodiment;

FIG. 2 shows an illustrative example of an environment in which an oil impregnated substrate is applied to a grated cooking surface to transfer an oil-based seasoning mixture from the oil impregnated substrate to the grated cooking surface in accordance with at least one embodiment;

FIG. 3 shows an illustrative example of an environment in which a substrate manufacturing system processes raw dry substrate to generate individual packages of oil impregnated substrate in accordance with at least one embodiment;

FIG. 4 shows an illustrative example of a process for preparing an oil-based seasoning mixture that can be used to impregnate a dry substrate with the oil-based seasoning mixture in accordance with at least one embodiment;

FIG. 5 shows an illustrative example of a process for impregnating a dry substrate with an oil-based seasoning mixture in accordance with at least one embodiment;

FIG. 6 shows an illustrative example of a process for automatic manufacturing and packaging of oil impregnated substrates in accordance with at least one embodiment; and

FIG. 7 shows an illustrative example of a process for applying an applicator onto a cooking surface in order to transfer the seasoning mixture infused into the applicator onto the cooking surface in accordance with at least one embodiment.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred examples of embodiment(s) only and is not intended to limit the scope, applicability or configuration of the disclosure. Rather, the ensuing description of the preferred examples of embodiment(s) will provide those skilled in the art with an enabling description for implementing a preferred examples of embodiment. It is understood that various changes can be made in the function and arrangement of elements without departing from the spirit and scope as set forth in the appended claims.

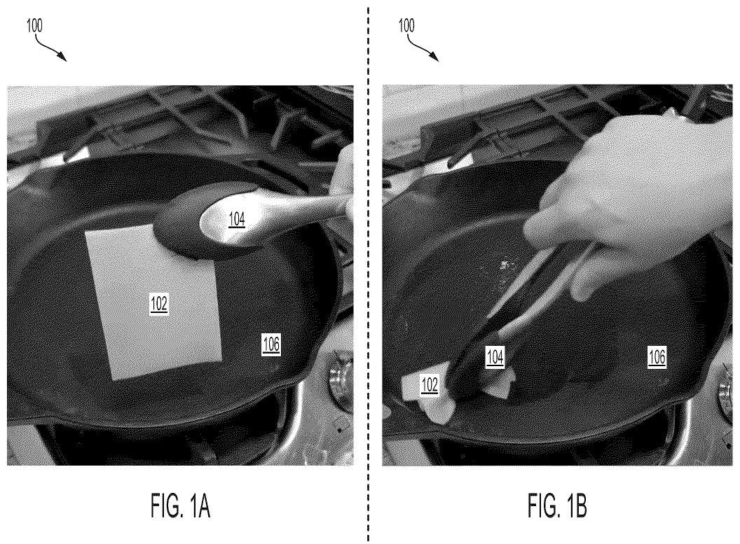

FIGS. 1A and 1B show an illustrative example of an environment 100 in which an oil impregnated substrate 102 is applied to a cooking surface 106 to transfer an oil-based seasoning mixture to the cooking surface 106 to season food being prepared on the cooking surface 106 in accordance with at least one embodiment. In the environment 100, and as illustrated in FIG. 1A. a user may use a cooking tool 104 (e.g., tongs, a spatula, a cooking fork, etc.) to secure an oil impregnated substrate 102 for application of an oil-based seasoning mixture from the oil impregnated substrate 102 onto a cooking surface 106. As illustrated in FIG. 1B, a user may gently wipe the oil impregnated substrate 102 on to a cooking surface 106 (e.g., a pan, a skillet, a wok, etc.) to transfer a oil-based seasoning mixture from the oil impregnated substrate 102 on to the cooking surface 106. In an embodiment, the oil impregnated substrate 102 may be saturated with the oil-based seasoning mixture on at least a portion of the oil impregnated substrate 102. The level of saturation of the oil impregnated substrate 102 with the oil-based seasoning mixture may be determined based on the characteristics of the oil-based seasoning mixture and the absorption qualities of the dry substrate used to generate the oil impregnated substrate 102, as described in greater detail herein, such that the oil-based seasoning mixture may be transferred onto the cooking surface 106 with gentle or minimal pressure. For example, a user may wipe the oil impregnated substrate 102 using a cooking tool 104, their own hand, or any other implement across the cooking surface 106 to transfer the oil-based seasoning mixture from the oil impregnated substrate 102 on to the cooking surface 106.

In an embodiment, the oil-based seasoning mixture comprises an oil suitable for cooking and one or more seasonings (e.g., spices, herbs, vinegar, etc.) that can be transferred from the oil impregnated substrate 102 on to a cooking surface by gently wiping the oil impregnated substrate 102 on to the cooking surface 106. The oil used in the oil-based seasoning mixture may be selected based on the smoke point of the oil and a desired range of temperatures for which the oil-based seasoning mixture may be used for preparation of the food. For instance, if the oil-based seasoning mixture is to be used for searing, pan-frying, roasting, grilling, or any other cooking method that requires a relatively high temperature (e.g., up to or above 570° F., etc.), an oil having a smoke point above this relatively high temperature may be selected. This may prevent the oil from breaking down and producing acrolein. Acrolein may produce an acrid smell and cause the food being prepared on the cooking surface 106 to have an undesirable acrid taste. Further, selection of an oil having a high smoke point may prevent the oil from producing smoke or igniting at higher temperatures. In some instances, the oil may further be selected based on its lubrication qualities. For example, an oil may be selected that prevents food from sticking to the cooking surface 106 at the desired range of temperatures during cooking. Further, these lubrication qualities may need to be preserved at higher temperatures, such that food does not stick to the cooking surface 106 as a result of the oil burning off at these higher temperatures.

The oil used in the oil-based seasoning mixture can further be selected based on the flash point of the oil and the desired range of temperatures for which the oil-based seasoning mixture is to be used for preparation of the food. Returning to an earlier example, whereby the oil-based seasoning mixture is to be used for searing, pan-frying, roasting, grilling, or any other cooking method that requires a relatively high temperature, an oil having a flash point above the required cooking temperature may be selected. This may prevent ignition of any oil vapors and further breakdown of the oil on the cooking surface during cooking. In some instances, any oil-based seasoning mixture impregnated into a dry substrate may be selected to be devoid of any alcohol-based ingredients, as alcohol may reduce the flash point of the oil-based seasoning mixture and thus increase the risk of oil ignition during cooking. Thus, the oil-based seasoning mixture may be devoid of any essential oils or other alcohol-infused oils.

In an embodiment, the oil used in the oil-based seasoning mixture can further be selected based on a desired flavor or seasoning profile for the food that is being prepared. For example, an oil for the oil-based seasoning mixture may be selected according to the one or more seasonings that are to be used for the oil-based seasoning mixture such that flavors inherent in the oil and the one or more seasonings may be detectable and favorable to the consumer. Further, the oil used in the oil-based seasoning mixture may be selected based on its shelf stability, such that the oil-based seasoning mixture itself may be shelf stable and not become rancid, spoil, develop mold, or otherwise become unusable after a period of time. Example oils that may be used include safflower oil, avocado oil, rice bran oil, olive oil, soybean oil, peanut oil, or any other suitable oil.

In an embodiment, the one or more seasonings are added to the selected oil to infuse these one or more seasonings into the oil. The one or more seasonings, as described above, may include spices, herbs, vinegars, and the like. In some instances, if spices or herbs are used as seasonings, these spices or herbs may be dried or otherwise prepared such that excess moisture is removed from the spices or herbs being used. Excess moisture may cause the oil to become rancid or otherwise become unusable for cooking (e.g., promote bacterial growth, spoil, develop mold, etc.). However, fresh spices or herbs may be used as seasonings for applications where long shelf life is not required for the oil-based seasoning mixture (e.g., the oil-based seasoning mixture is to be used within a short period of time after preparation and saturation into the substrate 102, etc.).

The selected oil and one or more seasonings may be stored in a tote, barrel, vat, or other container in order to infuse the one or more seasonings into the oil, producing the oil-based seasoning mixture. In some instances, the container used to create the oil-based seasoning mixture may be heated in order to emphasize the flavors of the oil and the one or more seasonings added to the oil-based seasoning mixture. The temperature used for heating the oil and the one or more seasonings in the container may be low (e.g., at or below 150° F.) in order to prevent cooking of the oil. Cooking of the oil during infusion may cause a change in the flavor profile of the oil-based seasoning mixture and impact its shelf life. The resulting oil-based seasoning mixture may be stored in the container at room temperature. The one or more seasonings may be kept with the oil in the container as long as desired. For instance, the longer that the one or more seasonings are maintained with the oil in the container, the stronger the flavor profile of the oil-based seasoning mixture may be. Once the desired flavor profile has been produced, the one or more seasonings may be removed from the container, such as through straining of the oil and the one or more seasonings. The resulting oil-based seasoning mixture may be returned to the container for impregnation of dry substrates to generate the oil impregnated substrates 102, as described in greater detail herein.

In another example, cold infusion of the oil may be performed to infuse the one or more seasonings into the oil. For instance, the one or more seasonings may be introduced into the oil within the container at room temperature. The oil and one or more seasonings may be strained in order to remove any solids from the oil-based seasoning mixture. Once strained, the oil-based seasoning mixture may be returned to the container for refrigeration in order to prevent spoilage of the oil-based seasoning mixture. Cold infusion of an oil to produce the oil-based seasoning mixture may allow for use of fresh herbs or other ingredients as flavoring agents for the oil-based seasoning mixture. However, the resulting oil-based seasoning mixture may be subject to expiration, as the moisture from the fresh herbs or other ingredients may cause the oil-based seasoning mixture to spoil after a limited amount of time.

In an embodiment, once the oil-based seasoning mixture has been prepared, the oil-based seasoning mixture may be injected, pressed, or otherwise impregnated into the substrate 102. For instance, any utensil configured to draw in a liquid solution and to eject the liquid solution on to the substrate 102 may be utilized (e.g., syringe, baster, injector, etc.). The substrate 102, in some instances, may be pre-folded such that introduction of the oil-based seasoning mixture using the utensil results in closely uniform distribution of the oil-based seasoning mixture within the substrate 102. The oil-based seasoning mixture may alternatively be impregnated into the substrate 102 by submersing the substrate 102 in the oil-based seasoning mixture within the container or other vessel (e.g., another container, tub, etc.). The substrate 102 may absorb the oil-based seasoning mixture such that the substrate 102 becomes impregnated or saturated for use on the cooking surface 106.

In an embodiment, the oil impregnated substrate 102 can be generated through an industrial process at mass scale. For example, rolls of dry substrate may be introduced to a substrate manufacturing system, which may automatically slit the rolls of dry substrate into individual dry substrate plies that may be impregnated to generate the oil impregnated substrate 102. A dry substrate ply may be introduced into a substrate package by the substrate manufacturing system, upon which an amount of oil-based seasoning mixture may be injected into the substrate package for impregnation of the dry substrate ply with the oil-based seasoning mixture. As described in greater detail herein, the amount of oil-based seasoning mixture that may be introduced into a substrate package is 0.25±0.05 fluid ounces.

Once the oil-based seasoning mixture has been introduced into a substrate package including a substrate 102, the substrate package may be heat sealed by the substrate manufacturing system. This may allow for continued exposure of the substrate 102 to the oil-based seasoning mixture in the substrate package, which may cause automatic impregnation of the substrate 102 with the oil-based seasoning mixture. Further, heat sealing of the substrate package may prevent drying out of the impregnated substrate 102 or environmental exposure of the impregnated substrate 102 to air, which may reduce the shelf life of the impregnated substrate 102.

The substrate 102 used for absorption of the oil-based seasoning mixture and for application of the oil-based seasoning mixture to a cooking surface 106 may include a fabric that is selected based on its absorption and strength properties. For example, in an embodiment, the substrate 102 may be constructed from a low lint tissue paper that is applied to a plastic web to provide the substrate 102 with an amount of strength suitable for transferring the oil-based seasoning mixture to a cooking surface 106 without falling apart or leaving behind any paper residue on the cooking surface 106. The material used to construct the substrate 102 may be selected based on the absorption and liquid retention properties of the substrate 102. In some instances, the substrate 102 may be constructed with multiple plies in order to increase the strength of the substrate 102 and to allow for greater absorption of the oil-based seasoning mixture into the substrate 102. In an embodiment, the substrate 102 is a felt that comprises a matted fabric that is constructed using recycled plastic and rolled into a substrate roll that may be introduced to the substrate manufacturing system for slitting, impregnation, and packaging. The felt may allow for absorption of the oil-based seasoning mixture and other liquid solutions into the matted fabric.

In some instances, the substrate 102 may be selected based on its ability to withstand a variety of temperatures over a period of time corresponding to application of the oil-based seasoning mixture to a cooking surface 106. For instance, the material used to manufacture the substrate 102 may be selected such that the substrate 102 does not burn or otherwise degrade while transferring the oil-based seasoning mixture from the substrate 102 onto the cooking surface 106 at any temperature. Further, the substrate 102 may be selected based on its ability to allow for the transfer of an impregnated liquid solution on to a cooking surface 106 at cooler temperatures (e.g., room temperature) with gentle or minimal force.

The substrate 102 may further be selected based on its transfer properties (e.g., ability to transfer a liquid impregnated into the substrate 102 onto a surface). For example, the fabric used to manufacture the substrate 102 may be selected according to its ability to allow for transfer of a liquid solution from the substrate 102 onto a surface with minimal pressure or force while providing sufficient strength to prevent degradation of the substrate 102 during the transfer. An example of a substrate 102 that may be used for absorption and transfer of an oil-based seasoning mixture onto a cooking surface 106 may include the FST-3000 wiper provided by Berk International, LLC. Another illustrative example of a substrate 102 that may be used for absorption and transfer of an oil-based seasoning mixture onto a cooking surface 106 may include the classic felt provided by Advanced Felt Solutions. However, any substrate known in the art that satisfies the aforementioned requirements for strength, durability, and absorption may be used.

As noted above, the substrate 102 may be gently wiped on the cooking surface 106 to transfer the oil-based seasoning mixture from the substrate 102 on to the cooking surface 106. In an embodiment, the substrate 102 can be gently wiped on the cooking surface 106 at any temperature. For instance, a user may manually (e.g., with their hand) wipe the cooking surface 106 with the substrate 102 to apply the oil-based seasoning mixture to the cooking surface 106 while the cooking surface 106 is at room temperature or any other temperature that does not pose a risk of burning or injury to the user. As another example, a user may grasp the substrate 102 using a pair of tongs or other gripping tool 104. Using the pair of tongs or other gripping tool 104, the user may wipe the substrate 102 along the cooking surface 106 to transfer the oil-based seasoning mixture from the substrate 102 to the cooking surface 106. Further, the use of a pair of tongs or other gripping tool 104 to wipe the substrate 102 along the cooking surface 106 (as illustrated in FIG. 1B) may allow the user to perform this operation at any cooking temperature and/or while the cooking surface 106 is hot. As a result of the thorough impregnation and saturation of the substrate 102 with the oil-based seasoning mixture, the oil-based seasoning mixture may be transferred to the cooking surface 106 with minimal force or pressure applied to the substrate 102 along the cooking surface 106.

In an embodiment, the amount of the oil-based seasoning mixture added to the substrate 102 is tailored such that gentle wiping of the substrate 102 on the cooking surface 106 allows for the cooking surface 106 to be lubricated while allowing for further transfer of the oil-based seasoning mixture to the food being prepared during cooking. The continued lubrication of the cooking surface 106 using the oil-based seasoning mixture may prevent the food on the cooking surface 106 from sticking to the cooking surface 106 and from burning. Further, as the food is rotated or otherwise moved along the cooking surface 106, a portion of the oil-based seasoning mixture may be transferred from the cooking surface 106 to the food itself, which creates a protective layer around the food to prevent burning of the food at various cooking temperatures. Additionally, as the food is being prepared on the cooking surface 106, this protective layer may allow for the food to retain its moisture.

As noted above, the oil used in the oil-based seasoning mixture may be selected based on its smoke point and flash point such that the oil does not ignite, burn, or degrade at higher cooking temperatures, such as at a maximum cooking temperature. However, the one or more seasonings infused into the oil may serve as aromatics, which may cause the oil-based seasoning mixture to produce an aroma corresponding to the one or more seasonings infused into the selected oil. This aroma may be infused into the food as the food is being cooked on the cooking surface 106, thereby introducing additional flavor into the food. Further, because the oil used in the oil-based seasoning mixture is selected based on its high smoke point, the risk of the oil burning and producing acrolein is reduced. Accordingly, this may reduce the risk of the oil-based seasoning mixture producing an acrid smell and causing the food being prepared on the cooking surface 106 to have an undesirable acrid taste.

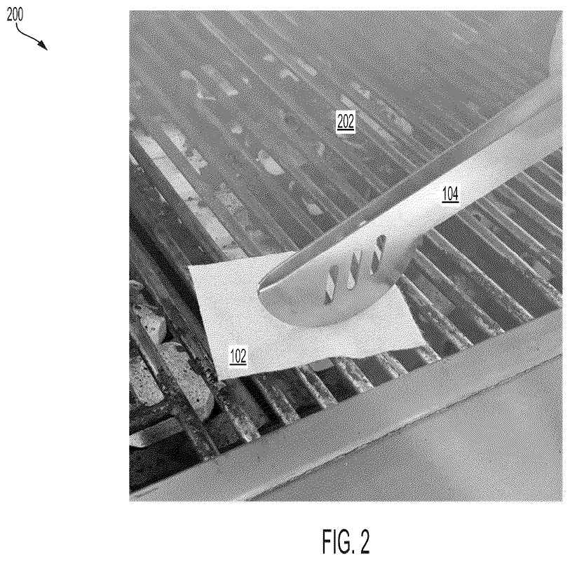

FIG. 2 shows an illustrative example of an environment 200 in which an oil impregnated substrate 102 is applied to a grated cooking surface 202 to transfer an oil-based seasoning mixture from the oil impregnated substrate 102 to the grated cooking surface in accordance with at least one embodiment. Similar to the environment 100 described above in connection with FIGS. 1A and 1B, a user may use a cooking tool 104 (e.g., tongs, a spatula, a cooking fork, etc.) to wipe the oil impregnated substrate 102 along the grated cooking surface 202 to transfer the oil-based seasoning mixture from the oil impregnated substrate 102 on to the grated cooking surface 202. In the environment 200, the grated cooking surface 202 may be a set of barbecue grill grates, which may sit over a set of burners or firebox (depending on the type of barbecue grill used) that, when in operation, may heat the grated cooking surface 202 and the cooking chamber of the barbecue grill. As illustrated in FIG. 2, the grated cooking surface 202 may be at an elevated temperature as a result of the barbecue grill being in operation. Thus, the user may use a cooking tool 104 to place the substrate 102 over the grated cooking surface 202 and to move the substrate 102 along the grated cooking surface 202 to transfer the oil-based seasoning mixture from the substrate 102 to the grated cooking surface 202.

As noted above, the substrate 102 can be gently wiped along a cooking surface at any temperature. For instance, a user may manually (e.g., with their hand) wipe the grated cooking surface 202 with the substrate 102 to transfer the oil-based seasoning mixture to the grated cooking surface 202 while the grated cooking surface 202 is at room temperature or any other temperature that does not pose a risk of burning or injury to the user. As another example, and as illustrated in FIG. 2, a user may grasp the substrate 102 using a pair of tongs or other gripping tool 104. Using the pair of tongs or other gripping tool 104, the user may wipe the substrate 102 along the grated cooking surface 202 to transfer the oil-based seasoning mixture from the substrate 102 to the grated cooking surface 202. Further, the use of a pair of tongs or other gripping tool 104 to wipe the substrate 102 along the grated cooking surface 202 allows the user to perform this operation at any cooking temperature and/or while the grated cooking surface 202 is hot. As a result of the thorough impregnation and saturation of the substrate 102 with the oil-based seasoning mixture, the oil-based seasoning mixture may be transferred from the substrate 102 on to the grated cooking surface 202 with minimal force or pressure.

As noted above, the substrate 102 may be selected based on its absorption and strength properties. For instance, the substrate 102 may need to be able to absorb an amount of the oil-based seasoning mixture such that the substrate 102 may be used to transfer an amount of the oil-based seasoning mixture on to a cooking surface and to allow for the transfer of the oil-based seasoning mixture from the cooking surface to the food being prepared on the cooking surface. Further, the amount of the oil-based seasoning mixture that is to be absorbed by the substrate 102 may need to be sufficient to allow for continued lubrication of the cooking surface as the oil-based seasoning mixture is transferred to the food during cooking. The substrate 102 may further need to transfer the oil-based seasoning mixture onto the cooking surface with minimal application of pressure or force.

In an embodiment, the substrate 102 is initially obtained as an unfolded wiper, disposable washcloth, or other textile created using natural and/or synthetic materials. The natural and/or synthetic materials used to manufacture the substrate 102 may be selected based on the absorption and strength properties of the materials. For instance, the substrate 102 may be manufactured using a low lint tissue paper that is applied to a plastic web to provide the substrate 102 with an amount of strength suitable for transferring the oil-based seasoning mixture to a cooking surface without falling apart or leaving behind any paper residue on the cooking surface. In some instances, the substrate 102 may be manufactured using a spunlace or other cellulose/polyester blend that provides desirable absorption and strength properties at any temperature. In an embodiment, the substrate 102 is manufactured using a felt comprising a matted fabric that is made from recycled plastic. The materials used to manufacture the substrate 102 may further be selected based on the ability of these materials to allow for transfer of a liquid solution (e.g., the oil-based seasoning mixture) from the substrate 102 on to a cooking surface using gentle or minimal pressure or force regardless of the temperature of the cooking surface.

As illustrated in FIGS. 1A and 2, the substrate 102 may be provided in the form of a sheet, whereby the substrate 102 may have a width of approximately 3 inches and a length of 4 inches. However, it should be noted that the length and width of the substrate 102 may differ and may be selected based on various factors. For instance, the length and width of the substrate 102 may be selected based on the dimensions of the cooking surfaces for which the substrate 102 may be used to transfer the oil-based seasoning mixture from the substrate 102 on to the cooking surface. In some instances, the length and width of the substrate 102 may be selected to accommodate the average size of the human hand, whereby a user may hold the substrate 102 using the palm of their hand to gently wipe the substrate 102 on a cooking surface to transfer the oil-based seasoning mixture from the substrate 102 on to the cooking surface. As another example, the length and width of the substrate 102 may be selected based on the desired dimensions of the substrate 102 for impregnation or other introduction of the oil-based seasoning mixture to the substrate 102 to allow for near uniform absorption and distribution of the oil-based seasoning mixture into the substrate 102. The length and width of the substrate 102 may further be selected based on the desired dimensions of the substrate 102 for packaging purposes.

In an embodiment, the substrate 102 can be folded into a square or other rectangular shape. For instance, the substrate 102 can be folded to form a folded substrate having a length of 2 inches and width of approximately 1.5 inches. Similar to the unfolded substrate described above, it should be noted that the dimensions of the folded substrate may be selected based on various factors. For instance, the dimensions of the folded substrate may be selected such that, when the oil-based seasoning mixture is impregnated or otherwise introduced to the folded substrate, the oil-based seasoning mixture is distributed as evenly as possible across various portions of the substrate 102. As another example, the dimensions of the folded substrate may be selected based on packaging and distribution considerations. For instance, the dimensions of the folded substrate may be selected to allow for easier packaging of the substrate 102 and to allow for a smaller form factor, which may enable easier distribution and delivery of the substrate 102 to consumers. In some instances, the dimensions of the folded substrate may be selected based on the absorption properties of the substrate 102. For example, the dimensions of the folded substrate may be minimized according to the rate of absorption of the material used to manufacture the substrate 102 such that impregnation or other introduction of the oil-based seasoning mixture into the folded substrate causes nearly uniform distribution of the oil-based seasoning mixture throughout the substrate 102.

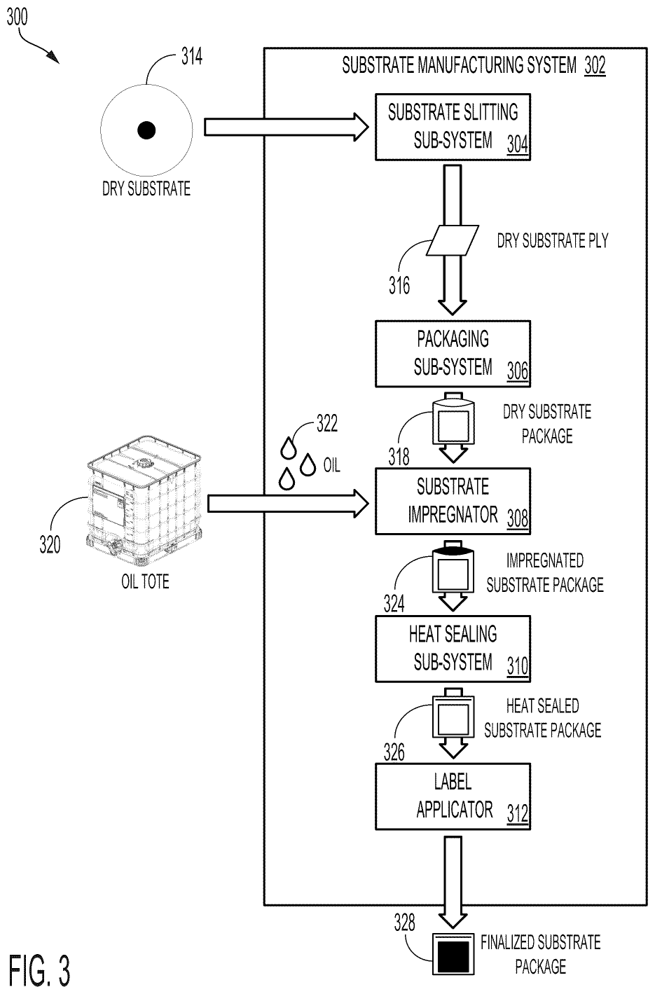

FIG. 3 shows an illustrative example of an environment 300 in which a substrate manufacturing system 302 processes raw dry substrate 314 to generate individual packages of oil impregnated substrate 328 in accordance with at least one embodiment. In the environment 300, a roll of raw dry substrate 314 is introduced to a substrate slitting sub-system 304 for slitting of the raw dry substrate 314 into individual dry substrate plies 316 that may be used to generate oil impregnated substrates. As noted above, each substrate may be provided in the form of a sheet, whereby the substrate may have a width of approximately 3 inches and a length of 4 inches. Thus, the roll of raw dry substrate 314 may also have a width of approximately 3 inches and an unrolled length that corresponds to the total number of dry substrate plies 316 that are to be used to create the substrates. For example, if the roll of raw dry substrate 314 is supplied to provide 25,000 dry substrate plies 316, each having a length of 4 inches, the unrolled length of the roll of raw dry substrate 314 is equal to 25,000×4 inches or 100,000 inches. It should be noted that the example dimensions provided above are for illustrative purposes and the ultimate dimensions of the roll of raw dry substrate 314 may be defined according to the desired dimensions for each substrate.

The substrate manufacturing system 302, in an embodiment, is a multi-component machine that is configured to produce wet substrates and to package these web substrates for distribution to consumers. An example of a substrate manufacturing system 302 that may be implemented for the manufacture and packaging of the substrate is the UT-BL10 flow pack wet wipes machine manufactured by Droid Group Co., LTD. The substrate manufacturing system 302 may include various components that, collectively, may impregnate and package the substrate for distribution for consumers. For instance, as noted above, the substrate manufacturing system 302 may include a substrate slitting sub-system 304, which may slit the roll of raw dry substrate 314 into individual dry substrate plies 316. The substrate slitting sub-system 304, in an embodiment, is programmed to unroll the roll of raw dry substrate 314 and slit the raw dry substrate according to the desired length for each dry substrate ply 316. For instance, if the substrate is to be 4 inches in length, the substrate slitting sub-system 304 may automatically unroll the roll of raw dry substrate 314 through one or more spindles and slit the unrolled raw dry substrate at 4-inch intervals to produce the individual dry substrate plies 316.

The substrate slitting sub-system 304 may feed the individual dry substrate plies 316 to a packaging sub-system 306, which may insert each individual dry substrate ply 316 into individual dry substrate packages 318. A dry substrate package 318 may be designed according to the dimensions of the substrate. For instance, a dry substrate package 318 may be designed to accommodate an unfolded substrate such that the dimensions of the substrate may be used to configure the dimensions of the dry substrate package 318. Alternatively, a dry substrate package 318 may be configured according to a desired folded shape of the substrate. Returning to an earlier example whereby the substrate can be folded to form a folded substrate having a length of 2 inches and width of approximately 1.5 inches, the dry substrate package may be designed to accommodate the folded substrate, thereby minimizing the form factor of the dry substrate package. In an embodiment, if the substrate is to be folded for insertion into the dry substrate package 318, the substrate slitting sub-system 304 may be programmed and configured to automatically fold the dry substrate ply 316 according to the desired folded substrate dimensions prior to introduction to the packaging sub-system 306. In some instances, the packaging sub-system 306 may be programmed and configured to fold the dry substrate ply 316 according to the desired folded substrate dimensions. The packaging sub-system 306 may arrange the dry substrate packages 318 into discrete rows to allow for simultaneous insertion of multiple dry substrate plies 316 into the dry substrate packages 318.

As the packaging sub-system 306 inserts the dry substrate plies 316 into the dry substrate packages 318, the packaging sub-system 306 may transfer the dry substrate packages 318 to a substrate impregnator 308 for introduction of the oil-based seasoning mixture 322 into the dry substrate packages 318. In an embodiment, and as illustrated in FIG. 3, the substrate impregnator 308 may obtain the oil-based seasoning mixture 322 from an oil tote 320 connected to the substrate manufacturing system 302. The oil tote 320, in an embodiment, is an intermediate bulk container tank (IBC) that is caged and mounted on to a pallet for delivery to and from the substrate manufacturing system 302. The oil tote 320 may be configured to allow for safe storage of the oil-based seasoning mixture to prevent spoilage during delivery to the substrate manufacturing system 302. The oil tote 320 may be connected to a pump or other distribution mechanism implemented through the substrate impregnator 308 for injection of the oil-based seasoning mixture 322 into the dry substrate packages 318 including the dry substrate plies 316.

As noted above, the amount of oil-based seasoning mixture 322 that may be injected into each dry substrate package 318 may be calibrated according to the absorption properties and dimensions of the dry substrate ply 316 included therein. For example, for a dry substrate ply 316 measuring 4 inches in length and 3 inches in width (e.g., 12 square inches), the amount of oil-based seasoning mixture that may be introduced into a dry substrate package 318 to allow for adequate impregnation of the substrate is 0.25±0.05 fluid ounces. Accordingly, the pump or other distribution mechanism implemented through the substrate impregnator 308 may be programmed or otherwise calibrated to inject, through a set of injectors implemented by the substrate impregnator 308, 0.25±0.05 fluid ounces into each dry substrate package 318, resulting in an impregnated substrate package 324.

The substrate impregnator 308 may transfer the impregnated substrate packages 324 to a heat sealing sub-system 310 for sealing of the impregnated substrate packages 324. The heat sealing sub-system 310 may implement a heating band or other heating element that may be used to apply heat along the open end of the impregnated substrate packages 324 to seal the impregnated substrate packages 324. In some instances, the heat sealing sub-system 310 may include a vacuum sealer, which may remove any air from the impregnated substrate packages 324 prior to heat sealing the impregnated substrate packages 324. This may remove any contaminants or other elements that may reduce the shelf life of the oil-based seasoning mixture. The resulting heat sealed substrate packages 326 may allow for natural and continued impregnation of the substrate enclosed therein with the oil-based seasoning mixture 322 previously injected into the package. The heat sealed substrate packages may be transferred from the heat sealing sub-system to a label applicator 312, which may automatically apply any product labels (e.g., brand details, nutritional information, ingredient information, etc.) and compile the resulting finalized substrate packages 328 for distribution.

As noted above, the oil-based seasoning mixture 322 may be stored in a vat, barrel, or other container from which the oil-based seasoning mixture 322 may be drawn or otherwise used to impregnate the substrate. The container used for the oil-based seasoning mixture 322 may have been previously used to generate the oil-based seasoning mixture 322. For instance, the oil and one or more seasonings to be included in the oil-based seasoning mixture 322 may be stored in the container in order to infuse the one or more seasonings into the oil, producing the oil-based seasoning mixture 322. In some instances, the container used to create the oil-based seasoning mixture 322 may be heated in order to bring out the flavors of the oil and the one or more seasonings of the oil-based seasoning mixture 322. The temperature used for heating the oil and the one or more seasonings in the container may be low in order to prevent cooking of the oil. The resulting oil-based seasoning mixture 322 may be stored in the container at room temperature. The one or more seasonings may be kept with the oil in the container as long as desired. Once the desired flavor profile has been produced, the one or more seasonings may be removed from the container, such as through straining of the oil and the one or more seasonings. The resulting oil-based seasoning mixture 322 may be returned to the container.

The oil-based seasoning mixture 322, as noted above, may also be generated using cold infusion of the oil using the one or more seasonings. For instance, the one or more seasonings may be introduced into the oil within the container at a cool or room temperature. The oil and one or more seasonings may be strained in order to remove any solids from the oil-based seasoning mixture 322. Once strained, the oil-based seasoning mixture 322 may be returned to the container for refrigeration in order to prevent spoilage of the oil-based seasoning mixture 322. As noted above, the cold infusion of an oil to produce the oil-based seasoning mixture 322 may allow for use of fresh herbs or other ingredients as flavoring agents for the oil-based seasoning mixture 322.

It should be noted that other methods may be implemented for generating the oil impregnated substrate. For instance, in an embodiment, a user (e.g., a human, an automated robotic arm, etc.) can introduce a syringe into the container to draw a set amount of the oil-based seasoning mixture 322 for use in impregnation the oil-based seasoning mixture 322 into the dry substrate plies 316. The amount of the oil-based seasoning mixture 322 drawn from the container may be determined based on one or more factors. For instance, the amount of the oil-based seasoning mixture 322 drawn from the container may be determined based on the size of the substrate, whereby the amount of the oil-based seasoning mixture 322 is determined such that, when injected into the substrate, at least a particular portion or area of the substrate is impregnated with the oil-based seasoning mixture 322. In some instances, the amount of the oil-based seasoning mixture 322 drawn from the container may be determined based on the absorption properties and dimensions of the substrate. For example, the amount of the oil-based seasoning mixture 322 may be determined such that when the amount of the oil-based seasoning mixture 322 is impregnated into the substrate, the oil-based seasoning mixture 322 may be absorbed throughout the various folds and layers of the substrate as uniformly as possible. Further, the amount of the oil-based seasoning mixture 322 may be determined such that the level of saturation within the substrate allows for transfer of the oil-based seasoning mixture 322 to a cooking surface or food with minimal effort (e.g., gentle wiping, etc.).

In an embodiment, the dry substrate plies 316 can be submersed into the oil-based seasoning mixture 322 within the container in order to saturate the substrates with the oil-based seasoning mixture 322. For instance, a user can add a dry substrate ply 316 to the oil-based seasoning mixture 322 in the container and apply a weight to the substrate in order to prevent the substrate from floating to the surface, which may hinder or delay the absorption of the oil-based seasoning mixture 322 into the substrate. The substrate may be kept submerged in the oil-based seasoning mixture 322 within the container for a period of time in order to ensure that the oil-based seasoning mixture 322 is absorbed throughout the layers and folds of the substrate. The impregnated substrate may be removed from the oil-based seasoning mixture 322 within the container and any excess oil-based seasoning mixture 322 may be returned to the container for use with other substrates.

Once the substrate has either been injected with the oil-based seasoning mixture 322 or has been submersed into the oil-based seasoning mixture 322 within the container and removed from the container, the substrate may be packaged for distribution. In some instances, if the substrate was unfolded during injection or submersion to impregnate the oil-based seasoning mixture 322 into the substrate, the substrate may be folded in order to allow for the substrate to be inserted into the packaging for distribution. For instance, as noted above, the substrate can be folded into a rectangular or square shape. The dimensions of the folded substrate may be selected to allow for easier packaging of the substrate and to allow for a smaller form factor, which may enable easier distribution and delivery of the substrate to consumers.

In some instances, the substrate may be folded prior to injection or submersion into the oil-based seasoning mixture 322. For instance, the substrate may be folded such that, when the oil-based seasoning mixture 322 is injected or otherwise impregnated into the folded substrate, the oil-based seasoning mixture 322 is distributed as evenly as possible across the various portions (e.g., layers and folds) of the substrate. As another example, the substrate may be folded based on the absorption properties of the substrate. For example, the substrate may be folded based on the rate of absorption of the material used to manufacture the substrate such that injection or other introduction of the oil-based seasoning mixture 322 into the folded substrate causes nearly uniform distribution of the oil-based seasoning mixture 322 throughout the substrate.

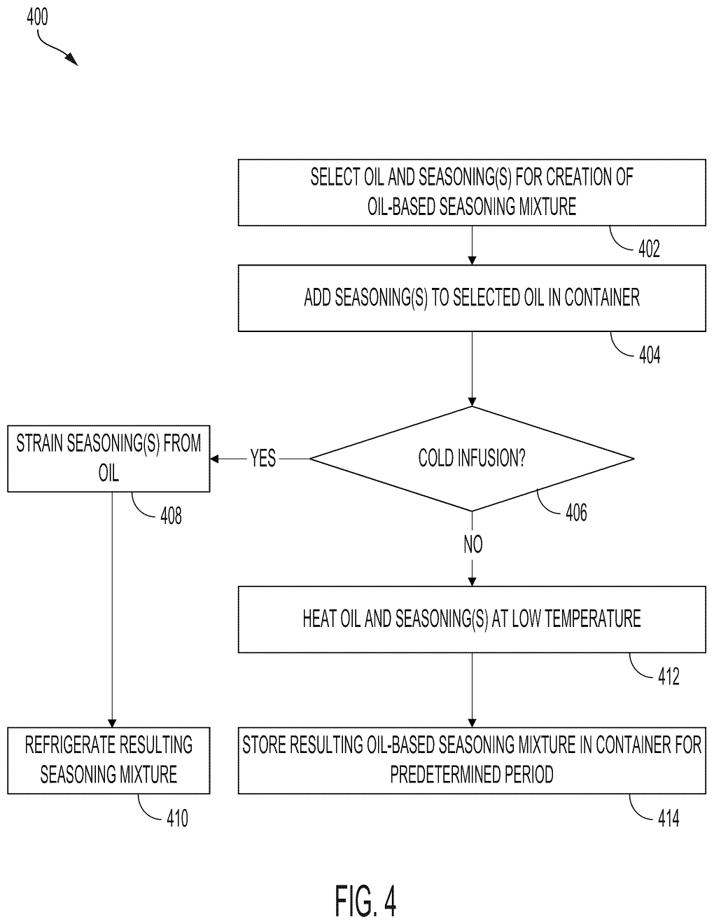

FIG. 4 shows an illustrative example of a process 400 for preparing an oil-based seasoning mixture that can be used to impregnate a dry substrate with the oil-based seasoning mixture in accordance with at least one embodiment. The process 400 may be performed by an entity (e.g., a user, an automated system, etc.) that may prepare the oil-based seasoning mixture based on a selection of an oil and corresponding one or more seasonings that are to be infused into the oil in order to create the oil-based seasoning mixture. Further, based on the type of infusion being performed, the entity may also utilize a heating apparatus (e.g., oven, heating surface, etc.) to infuse the one or more seasonings into the oil, as described herein.

At step 402, the entity may select an oil and one or more seasonings for creation of an oil-based seasoning mixture that may be infused or otherwise added to an applicator. The oil used in the oil-based seasoning mixture may be selected based on the smoke point of the oil, the flash point of the oil, and a desired range of temperatures for which the oil-based seasoning mixture may be used. For instance, if the oil-based seasoning mixture is to be used for searing, pan-frying, roasting, grilling, or any other cooking method that requires a relatively high cooking temperature, an oil having a smoke point and flash point at or above this cooking temperature may be selected. This may prevent the oil from breaking down and producing acrolein, which may produce an acrid smell and cause the food being prepared to have an undesirable acrid taste. Further, this may prevent the oil from producing smoke or igniting at higher temperatures. In some instances, the oil may further be selected based on its lubrication qualities. For example, an oil may be selected that prevents food from sticking to a cooking surface during cooking. Further, these lubrication qualities may need to be preserved at higher temperatures, such that food does not stick to the cooking surface as a result of the oil burning off at these higher temperatures.

The one or more seasonings that are to be infused into the oil may be selected based on the desired flavor profile for the oil-based seasoning mixture. For example, habanero peppers, onion, garlic, and other seasonings may be selected based on a desired flavor profile that requires a level of spiciness while providing a robust taste experience. As another example, mesquites, rosemary, thyme, and other herbs and spices may be selected based on a desired flavor profile commonly associated with poultry, soups, stews, and the like. Thus, the one or more seasonings may be selected from any available herbs, spices, and/or other ingredients according to a desired flavor profile.

In an embodiment, the one or more seasonings are selected based on the type of infusion that is to be performed. For example, as described in greater detail herein, if the oil-based seasoning mixture is to be prepared using heat infusion, the selected spices or herbs may be dried or otherwise prepared such that excess moisture is removed from the spices or herbs being used. Excess moisture may cause the oil to become rancid or otherwise become unusable for cooking (e.g., promote bacterial growth, spoil, develop mold, etc.) over time. Alternatively, if the oil-based seasoning mixture is to be prepared using cold infusion, fresh herbs and spices may be used to prepare the oil-based seasoning mixture. However, the resulting oil-based seasoning mixture may need to be refrigerated and/or used within a shorter period of time in order to prevent spoilage of the oil-based seasoning mixture.

At step 404, the entity may add the selected one or more seasonings to the selected oil within a container. The container may be a tote, barrel, vat, or other vessel that may accommodate the selected oil and one or more seasonings such that the quantity of resulting seasoning mixture may be used for preparing a set of substrates. Further, the container may allow for safe storage and transport of the oil and one or more seasonings to facilitate the infusion of the one or more seasonings into the oil. In some instances, if the container is to be used for heating of the oil and one or more seasonings as part of the infusion process, the container may be selected such that the materials used to construct or manufacture the container do not leech into the oil, affecting the flavor profile of the resulting seasoning mixture.

At step 406, the entity may determine whether cold infusion is to be performed in order to prepare the oil-based seasoning mixture. As noted above, the selection of the one or more seasonings may impact whether cold infusion of these seasonings into the oil is to be performed. For instance, if the desired flavor profile requires use of fresh herbs and spices, cold infusion of these herbs and spices may be used in order to allow for proper infusion of these seasonings into the oil without immediate spoilage of the oil. Alternatively, if the desired flavor profile allows for use of dried herbs and spices, heat infusion of these seasonings may be performed to create the oil-based seasoning mixture.

If cold infusion is selected for creating the seasoning mixture, the entity, at step 408, may strain the one or more seasonings from the oil in order to remove as many solids as possible. These solids, if not removed, may accelerate spoilage of the oil, thereby reducing the shelf life of the resulting oil-based seasoning mixture. In some instances, the one or more seasonings added to the oil may be pulverized, minced, or finely sliced, resulting in different size solids within the oil during infusion. As such, straining the oil to remove these solids may require different tools for straining the oil (e.g., cheesecloths, colanders, filtration systems, etc.).

At step 410, the entity may refrigerate the resulting oil-based seasoning mixture in order to preserve the oil-based seasoning mixture for later use. As noted above, an oil-based seasoning mixture prepared using fresh seasonings may have a shorter shelf life, such that the oil-based seasoning mixture may need to be used within a limited period of time in order to prevent spoilage of the oil-based seasoning mixture. Refrigeration of the resulting oil-based seasoning mixture may extend the shelf life of the oil-based seasoning mixture.

In an embodiment, if heat infusion is to be used in order to infuse the one or more seasonings into the selected oil, the entity, at step 412, can heat the oil and one or more seasonings at a low temperature in order to allow for the mixture to steep. The heating of the oil and the one or more seasonings may cause the one or more seasonings to break down, which may allow for the infusion of the constituents of the one or more seasonings into the oil. The temperature used for heating the oil and the one or more seasonings in the container may be low (e.g., at or below 150° F.), as cooking of the oil during infusion may cause a change in the flavor profile of the seasoning mixture and impact its shelf life.

At step 414, the resulting oil-based seasoning mixture may be stored in the container at room temperature. The one or more seasonings may be kept with the oil in the container as long as desired. For instance, the longer that the one or more seasonings are maintained with the oil in the container, the stronger the flavor profile of the oil-based seasoning mixture may be. Once the desired flavor profile has been produced, the one or more seasonings may be removed from the container, such as through straining of the oil and the one or more seasonings as described above. The resulting oil-based seasoning mixture may be returned to the container for impregnation of the substrates.

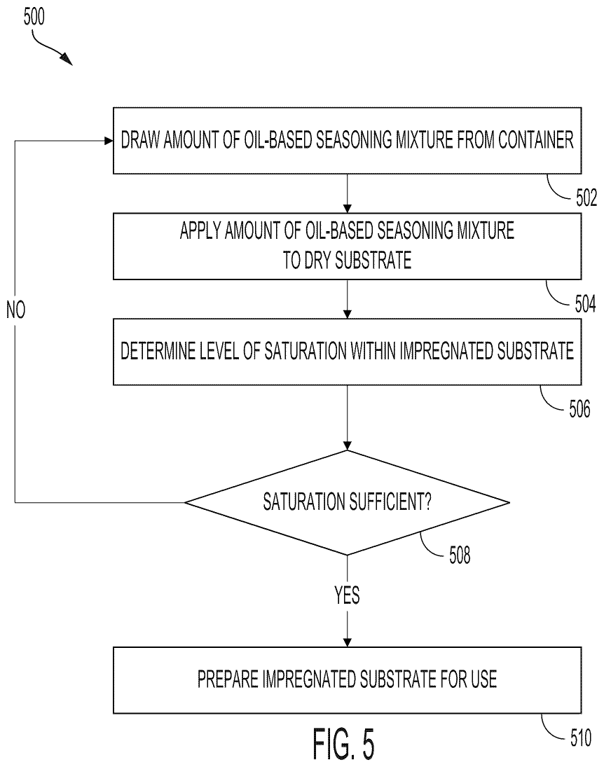

FIG. 5 shows an illustrative example of a process 500 for impregnating a dry substrate with an oil-based seasoning mixture in accordance with at least one embodiment. The process 500 may be performed by an entity (e.g., a user, an automated system, etc.) that may inject or otherwise introduce an oil-based seasoning mixture into a dry substrate in order to impregnate the substrate with the oil-based seasoning mixture for use on cooking surfaces. In some instances, the process 500 may be automated, whereby a robotic device or other automated system may perform one or more of the steps described herein.

At step 502, an entity may draw an amount of the oil-based seasoning mixture from a container used to store the oil-based seasoning mixture. As noted above, the container may be a tote, barrel, vat, or other vessel that may accommodate the oil-based seasoning mixture that is used for preparation of the substrate. To draw the amount of the oil-based seasoning mixture from the container, the entity may use a syringe or other tool (e.g., baster, injector, pump, etc.) that may be introduced into the oil-based seasoning mixture within the container. Further, the amount of the oil-based seasoning mixture drawn from the container may be determined based on one or more factors. For instance, the amount of the oil-based seasoning mixture may be determined based on the size of the substrate, such that when the oil-based seasoning mixture is introduced to the substrate, at least a particular portion or area of the substrate is saturated with the oil-based seasoning mixture. In some instances, the amount of the oil-based seasoning mixture may be determined based on the absorption properties of the substrate. Further, the amount of the oil-based seasoning mixture may be determined such that the level of saturation within the substrate allows for transfer of the oil-based seasoning mixture to a cooking surface or food with minimal effort.

At step 504, the entity may apply the amount of oil-based seasoning mixture drawn from the container onto a dry substrate. For instance, the entity may inject the oil-based seasoning mixture drawn from the container directly into the dry substrate in order to saturate the substrate with the oil-based seasoning mixture. The entity may continuously apply the amount of the oil-based seasoning mixture into the substrate until either the entire amount is applied to the substrate or until a pre-determined level of saturation is achieved. For instance, at step 506, the entity can determine the level of saturation within the substrate as the amount of oil-based seasoning mixture is injected into the substrate. To determine the level of saturation, the entity may examine the substrate to determine whether the oil-based seasoning mixture has been absorbed into each of the layers of the substrate such that the substrate may be wiped, with minimal pressure or force, on a cooking surface to transfer the oil-based seasoning mixture onto the cooking surface.

It should be noted that while injection of the oil-based seasoning mixture is used extensively throughout the present disclosure for the purpose of illustration, other techniques may be used to saturate the substrate with the oil-based seasoning mixture. For example, the entity may submerse the dry substrate in the oil-based seasoning mixture within the container. The substrate may absorb the oil-based seasoning mixture such that the substrate becomes saturated for use on the cooking surface. As another illustrated example, the oil-based seasoning mixture may be injected into a dry substrate package containing the substrate such that, when the substrate package is sealed, the oil-based seasoning mixture may be automatically absorbed by the substrate within the substrate package.

At step 508, the entity may determine whether the level of saturation is acceptable. As noted above, the entity may examine the substrate to determine whether the oil-based seasoning mixture has been absorbed into each of the layers of the substrate such that the substrate may be wiped, with minimal pressure or force, on a cooking surface to transfer the oil-based seasoning mixture onto the cooking surface. If the entity determines that the substrate is not sufficiently saturated, the entity may draw another amount of the oil-based seasoning mixture from the container and apply this amount to the substrate, thereby repeating the process 500.

If the entity determines that the substrate is properly saturated, the entity, at step 510, may prepare the saturated substrate for use. For instance, the substrate may be packaged for distribution. In some instances, if the substrate was unfolded during injection or submersion to impregnate the substrate with the oil-based seasoning mixture, the substrate may be folded in order to allow for the substrate to be inserted into the packaging for distribution. For instance, the substrate can be folded into a rectangular or square shape. The dimensions of the folded substrate may be selected to allow for easier packaging of the substrate and to allow for a smaller form factor, which may enable easier distribution and delivery of the substrate to consumers. If the substrate was folded prior to injection or submersion, the substrate may be packaged in its folded configuration without performing any additional adjustment of the substrate.

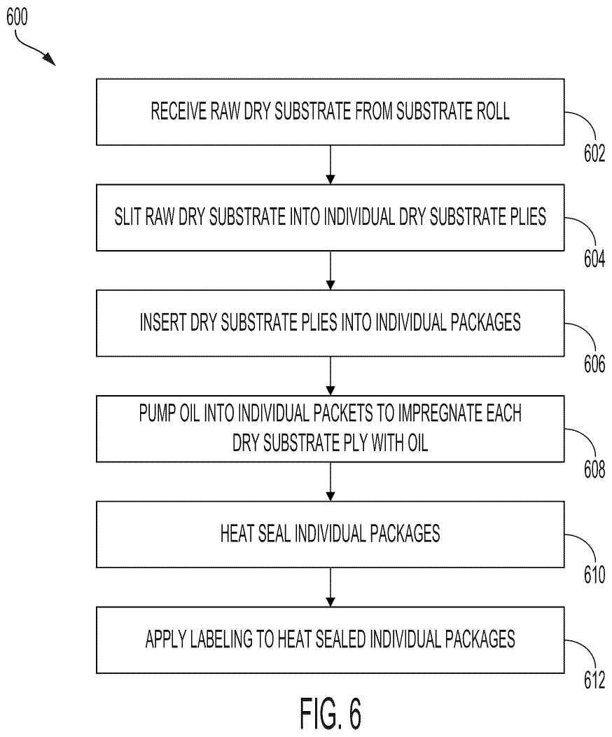

FIG. 6 shows an illustrative example of a process 600 for automatic manufacturing and packaging of oil impregnated substrates in accordance with at least one embodiment. The process 600 may be performed by a substrate manufacturing system programmed and configured to automatically impregnate raw dry substrate with an oil-based seasoning mixture and to package the resulting impregnated substrate for delivery to consumers.

At step 602, the substrate manufacturing system may receive raw dry substrate from a substrate roll. The substrate roll may be configured according to the desired dimensions for the resulting substrate. For instance, if the substrate is to have a width of approximately 3 inches and a length of 4 inches, the substrate roll may be configured to also have a width of approximately 3 inches and an unrolled length that corresponds to the total number of dry substrate plies that are to be used to create the substrates. Returning to an earlier example, if the substrate roll is supplied to provide 25,000 dry substrate plies, each having a length of 4 inches, the unrolled length of the substrate roll is equal to 25,000×4 inches or 100,000 inches. The substrate roll may be loaded on to a spindle or other receiving mechanism of the substrate manufacturing system.

At step 604, the substrate manufacturing system may slit the raw dry substrate from the substrate roll into individual dry substrate plies. For instance, the substrate manufacturing system may include a substrate slitting sub-system that may unroll the substrate roll and slit the raw dry substrate according to the desired length for each dry substrate ply. For instance, if the substrate is to be 4 inches in length, the substrate slitting sub-system of the substrate manufacturing system may automatically unroll the substrate roll through one or more spindles and slit the unrolled raw dry substrate at 4-inch intervals to produce the individual dry substrate plies.

At step 606, as the raw dry substrate from the substrate roll is slit into individual dry substrate plies, the substrate manufacturing system may insert each dry substrate ply into an individual substrate package. For instance, the substrate slitting sub-system may automatically feed the individual substrate plies to a packaging sub-system of the substrate manufacturing system. The packaging sub-system may automatically insert an individual dry substrate ply into a corresponding substrate package. As noted above, a substrate package may be designed according to the desired packed dimensions for the substrate. For instance, a substrate package may be designed to accommodate an unfolded substrate such that the dimensions of the substrate may be used to configure the dimensions of the dry substrate package. Alternatively, a substrate package may be configured according to a desired folded shape of the substrate. Based on the dimensions of the substrate package and the desired shape of the substrate within the substrate package, the packaging sub-system may configure the dry substrate ply to allow for insertion of the dry substrate ply into the substrate package. For example, if the substrate is to be folded for insertion into the substrate package, the substrate may be folded by either the substrate slitting sub-system prior to introduction to the packaging sub-system or by the packaging sub-system according to the desired folded substrate dimensions. In some instances, the packaging sub-system may arrange the substrate packages into discrete rows to allow for simultaneous insertion of multiple dry substrate plies into the substrate packages.

At step 608, the substrate manufacturing system may pump an amount of the oil-based seasoning mixture into each individual substrate package to impregnate the dry substrate within with the oil-based seasoning mixture. For instance, as the packaging sub-system inserts the dry substrate plies into individual substrate packages, the packaging sub-system may transfer the substrate packages to a substrate impregnator of the substrate manufacturing system for impregnation of the dry substrate plies included in the substrate packages. As noted above, the substrate impregnator may be connected to an oil tote or other container that contains the oil-based seasoning mixture. The oil tote or other container may be connected to a pump or other distribution mechanism implemented through the substrate impregnator for injection of the oil-based seasoning mixture into the substrate packages including the dry substrate plies. As noted above, the amount of oil-based seasoning mixture that may be injected into each substrate package may be calibrated according to the absorption properties and dimensions of the dry substrate ply included therein. Returning to an earlier example, whereby a dry substrate ply measuring 4 inches in length and 3 inches in width is provided, the amount of oil-based seasoning mixture that may be introduced into a substrate package containing a dry substrate ply to allow for adequate impregnation of the substrate is 0.25±0.05 fluid ounces. Accordingly, the pump or other distribution mechanism implemented through the substrate impregnator may be programmed or otherwise calibrated to inject 0.25±0.05 fluid ounces into each substrate package.

At step 610, the substrate manufacturing system may heat seal the impregnated substrate packages. For instance, as the substrate impregnator injects the oil-based seasoning mixture into each substrate package, the substrate impregnator may transfer the substrate package to a heat sealing sub-system of the substrate manufacturing system. As noted above, the heat sealing sub-system may implement a heating band or other heating element that may be used to apply heat along the open end of the impregnated substrate packages to seal the impregnated substrate packages. In some instances, the heat sealing sub-system may implement a vacuum sealer, which may remove any air from the impregnated substrate packages prior to heat sealing the impregnated substrate packages. This may remove any contaminants or other elements that may reduce the shelf life of the oil-based seasoning mixture. The resulting heat sealed substrate packages may allow for natural and continued impregnation of the substrate enclosed therein with the oil-based seasoning mixture.

At step 612, the substrate manufacturing system may apply labeling to the heat sealed substrate packages and prepare these packages for distribution to consumers. For instance, as the heat sealing sub-system seals each substrate package, the heat sealing sub-system may automatically transfer the sealed substrate package to a label applicator implemented by the substrate manufacturing system for application of one or more labels to the substrate package. The one or more labels may include a set of product labels (e.g., brand details, nutritional information, ingredient information, etc.). Once the labeling applicator has applied the requisite labels to the substrate packages, the labeling applicator may compile the resulting finalized substrate packages for distribution to consumers. For instance, the labeling applicator may arrange the substrate packages into pallets, boxes, or other containers that may be transported or otherwise distributed to ordering entities (e.g., consumers, restaurants, wholesalers, stores, etc.).

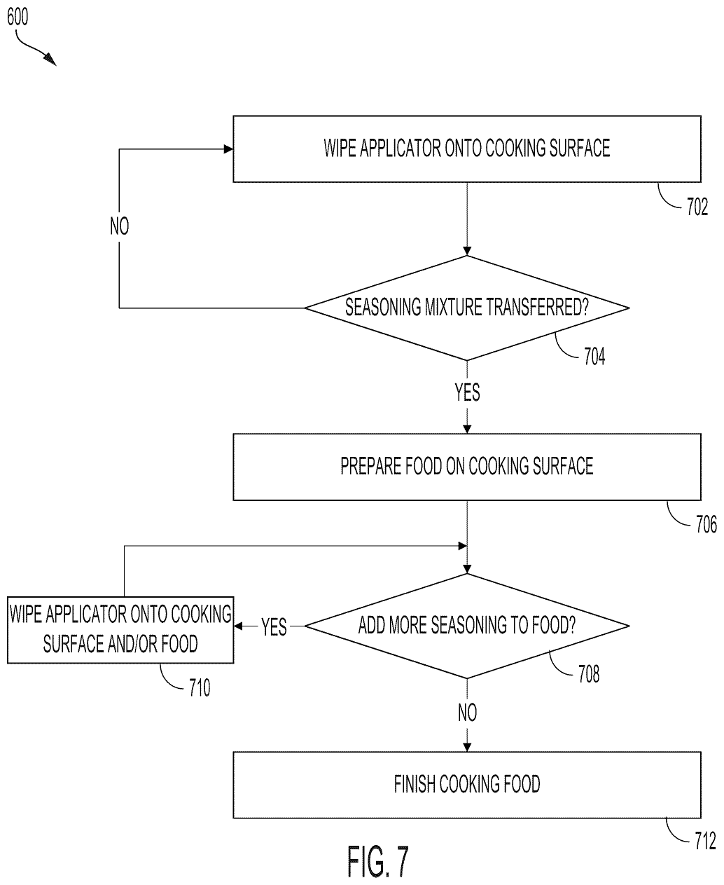

FIG. 7 shows an illustrative example of a process 700 for applying an oil-infused substrate onto a cooking surface in order to transfer the oil-based seasoning mixture infused into the oil-infused substrate onto the cooking surface in accordance with at least one embodiment. The process 600 may be performed by a consumer of the oil-infused substrate, which may apply the oil-infused substrate onto a cooking surface and/or food in order to season the food and to lubricate the cooking surface in order to prevent burning of the food and to preserve moisture within the food.

At step 702, the consumer may wipe the oil-infused substrate onto a cooking surface to transfer at least a portion of the oil-based seasoning mixture from the oil-infused substrate onto the cooking surface. The oil-infused substrate can be gently wiped on to the cooking surface at any temperature. For instance, a consumer may manually (e.g., with their hand) wipe the cooking surface with the oil-infused substrate to apply the oil-based seasoning mixture to the cooking surface while the cooking surface is at room temperature or any other temperature that does not pose a risk of burning or injury to the consumer. As another example, a consumer may grasp the oil-infused substrate using a pair of tongs or other gripping tool. Using the pair of tongs or other gripping tool, the consumer may wipe the oil-infused substrate along the cooking surface to transfer the oil-based seasoning mixture to the cooking surface. The use of a pair of tongs or other gripping tool to wipe the oil-infused substrate may allow the user to perform this operation at any cooking temperature and/or while the cooking surface is hot. As a result of the thorough saturation of the oil-infused substrate with the seasoning mixture, the seasoning mixture may be transferred to the cooking surface with minimal force or pressure applied to the oil-infused substrate along the cooking surface.

At step 704, the consumer may determine whether the oil-based seasoning mixture has been transferred from the oil-infused substrate on to the cooking surface as desired. For instance, the consumer may monitor the cooking surface to determine whether it exhibits a sheen or other indication of proper lubrication as a result of application of the oil-based seasoning mixture from the oil-infused substrate. If the consumer determines that the oil-based seasoning mixture has not been transferred sufficiently on to the cooking surface, the consumer may again wipe the oil-infused substrate on to the cooking surface to further coat the cooking surface with the oil-based seasoning mixture.

If the consumer determines that the oil-based seasoning mixture has been transferred from the oil-infused substrate onto the cooking surface, the consumer, at step 706, may begin preparing their food on the cooking surface. As noted above, because the oil used in the oil-based seasoning mixture is selected based on its smoke point, the consumer may prepare their food at a wide range of cooking temperatures without risking breakdown or burning of the oil. Further, as the consumer rotates and moves the food along the cooking surface, a portion of the oil-based seasoning mixture may be transferred from the cooking surface on to the food, thereby seasoning the food and coating the food with the oil-based seasoning mixture. This coating may allow for the food to retain its moisture and absorb the aroma created during cooking.

As the food is being prepared on the cooking surface, the consumer, at step 708, may determine whether to add more seasoning to the food. For instance, if it is desired to imbue the food with more flavor, the consumer, at step 710, may wipe the oil-infused substrate directly on to the food and/or on to the cooking surface to allow for greater coating of the food with the oil-based seasoning mixture. Further, wiping the oil-infused substrate on to cooking surface at the desired cooking temperature may cause the oil-based seasoning mixture to produce an aroma that may be pleasing and may also add flavor to the food. If the adequate amount of seasoning has been applied to the food, the user, at step 712, may finish cooking the food.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method, comprising:
receiving a substrate roll, wherein the substrate roll is sized according to a pre-defined set of dimensions for individual substrates and a resulting quantity of the individual substrates;
slitting the substrate roll according to the pre-defined set of dimensions to obtain the individual substrates;
automatically inserting the individual substrates into corresponding individual substrate packages, wherein the individual substrate packages are sized according to the pre-defined set of dimensions for the individual substrates;
injecting an amount of an oil-based seasoning mixture into the individual substrate packages, wherein the amount of the oil-based seasoning mixture is defined according to a set of absorption properties of the individual substrates and the pre-defined set of dimensions;
sealing the individual substrate packages, wherein when the individual substrate packages are sealed, the individual substrates absorb the amount of the oil-based seasoning mixture; and
providing the sealed individual substrate packages.

2. The method of claim 1, wherein the oil-based seasoning mixture comprises an oil having a smoke point corresponding to a maximum cooking temperature for cooking of food, and wherein the oil does not burn at the maximum cooking temperature.

3. The method of claim 1, wherein the oil-based seasoning mixture comprises an oil and a set of seasonings, wherein the set of seasonings are infused into the oil by heating the set of seasonings and the oil within a container, and wherein the set of seasonings and the oil are heated within the container without cooking the oil.

4. The method of claim 1, wherein the individual substrates are constructed using a polyester felt, and wherein the polyester felt is generated using recycled plastic.

5. The method of claim 1, wherein the amount of the oil-based seasoning mixture is between 0.20 and 0.30 fluid ounces per individual substrate package of the individual substrate packages.

6. The method of claim 1, wherein the amount of the oil-based seasoning mixture is injected into the individual substrate packages by pumping the amount of the oil-based seasoning mixture from an oil tote through a set of injectors into the individual substrate packages.

7. The method of claim 1, wherein the oil-based seasoning mixture comprises an oil having a flash point corresponding to a maximum cooking temperature for cooking of food, and wherein vapors generated from the oil during cooking do not ignite at the maximum cooking temperature.

8. The method of claim 1, wherein the individual substrate packages are sealed by removing excess air from the individual substrate packages and applying heat along an open end of the individual substrate packages.

9. The method of claim 1, wherein the oil-based seasoning mixture includes an oil chosen from a group consisting of safflower oil, avocado oil, rice bran oil, olive oil, soybean oil, and peanut oil.

10. The method of claim 1, wherein the individual substrates allow for a transfer of the oil-based seasoning mixture from the individual substrates to a cooking surface at room temperature and using gentle force.

11. A substrate, comprising:
a felt, wherein the felt comprises a matted fabric that allows for absorption of liquid solutions into the matted fabric, and wherein the felt allows for transfer of the liquid solutions from the matted fabric on to a cooking surface through a wiping motion performed along the cooking surface at a room temperature or a cooking temperature; and
an oil-based seasoning mixture that is impregnated into the matted fabric to saturate the felt, wherein the oil-based seasoning mixture comprises:
an oil suitable for cooking of a food, wherein the oil is selected based on a smoke point associated with the oil, and wherein the smoke point corresponds to the cooking temperature; and
one or more seasonings, wherein the one or more seasonings are infused into the oil.

12. The substrate of claim 11, wherein the oil-based seasoning mixture is impregnated into the matted fabric using a set of injectors, and wherein the oil-based seasoning mixture is pumped into the set of injectors from a container in order to inject the oil-based seasoning mixture into the matted fabric.

13. The substrate of claim 11, wherein the matted fabric is generated using a polyester constructed using recycled plastic.

14. The substrate of claim 11, wherein the smoke point associated with the oil corresponds to a maximum cooking temperature for cooking of the food, and wherein the oil does not burn at the maximum cooking temperature.

15. The substrate of claim 11, wherein the oil is further selected based on a flash point associated with the oil, wherein the flash point corresponds to a maximum cooking temperature, and wherein vapors generated from the oil during cooking do not ignite at the maximum cooking temperature.

16. The substrate of claim 11, wherein an amount of the oil-based seasoning mixture used for saturation of the felt is between 0.20 and 0.30 fluid ounces.

17. The substrate of claim 11, wherein the one or more seasonings are infused into the oil by heating the one or more seasonings and the oil within a container, and wherein the one or more seasonings and the oil are heated within the container without cooking the oil.

18. The substrate of claim 11, wherein the oil is chosen from a group consisting of safflower oil, avocado oil, rice bran oil, olive oil, soybean oil, and peanut oil.

19. The substrate of claim 11, wherein the felt further allows for transfer of the liquid solutions from the matted fabric to the cooking surface at a room temperature.

20. The substrate of claim 11, wherein the felt further allows for transfer of the liquid solutions from the matted fabric to the cooking surface at the cooking temperature.
